(19) United States
(12) Patent Application Publication
(10) Pub. No.: US 2011/0240499 A1
(43) Pub. Date: Oct. 6, 2011

(54) GLASS ROLL AND METHOD FOR MANUFACTURING THE SAME

(76) Inventors: Katsuhiro TANIGUCHI, Shiga (JP); Takahiro Kimura, Shiga (JP); Hiromichi Umemura, Shiga (JP)

(21) Appl. No.: 13/073,258

(22) Filed: Mar. 28, 2011

(30) Foreign Application Priority Data
Mar. 29, 2010 (JP) 2010-076178

(51) Int. Cl. B65D 85/04; B32B 1/08

(52) U.S. Cl. 206/389; 428/34.4; 428/219

(57) ABSTRACT

Provided is a glass roll (15) manufactured by winding a glass film (10) having a thickness of 0.5 to 300 μm and a density of less than 2.45 g/cm³ in a roll shape with a view to suppressing the damage of a glass film at an inner layer portion of a glass roll when the glass roll is manufactured by winding a long glass film having a thickness of 0.5 to 300 μm.

### TECHNICAL FIELD

The present invention relates to a glass roll obtained by winding a glass film, the glass film being used for a glass substrate of a flat panel display such as a liquid crystal display or an organic EL display, for a glass substrate of a device such as a solar cell, a lithium ion battery, a digital signage, a touch panel, or electronic paper, for the cover glass of a device such as an organic EL lighting, for a drug package, for a glass-resin laminate, and the like.

### BACKGROUND ART

In recent years, in view of space saving, there are widely used flat panel displays, such as a liquid crystal display, a plasma display, an organic EL display, and a field emission display, in place of a CRT display. Such flat panel displays are required to be further thinned. In particular, the organic EL display is required to allow easy carrying by being folded or wound, and to allow use not only on a flat surface but also on a curved surface. Further, a device required to allow the use not only on a flat surface but also on a curved surface is not limited to the display. It is also required to form a solar cell or an organic EL lighting, for example, on a surface of a product having a curved surface, such as a surface of a vehicle body of an automobile, or a roof, pillar, or outer wall of a building. Therefore, various glass plates including the flat panel display are required to be further thinned for satisfying a demand for flexibility high enough to deal with a curved surface. As disclosed, for example, in Patent Literatures 1 and 2, a film-like sheet glass having a thickness of less than 0.4 mm has been developed.

### CITATION LIST

### Patent Literature

[PTL 1] JP 2000-335928 A
[PTL 2] JP 2002-544104 A

### SUMMARY OF THE INVENTION

### Problems to be Solved by the Invention

By the way, from the viewpoint of ensuring the flexibility of a flat panel display, it may be possible to use a resin film as a substitute for a glass plate. However, the resin film has a problem in that the resin film is inferior to the glass plate in barrier property for gas (gas-barrier property). If an organic EL display is taken as an example, a light-emitting member used deteriorates in quality through the contact with gasses such as oxygen and water vapor, and hence the resin film, which has lower gas-barrier property, cannot be used as a substitute for the glass plate. Thus, from the viewpoint of ensuring gas-barrier property as well, the actual situation is that developing a glass plate having a smaller thickness is becoming much more important.

Further, when a glass plate having a smaller thickness is developed, the glass plate can be wound into a roll shape. Thus, it is conceivable that the roll shape is a preferred packing form from the viewpoints of space saving, easy handling at the time of packing, and the like.

However, as illustrated in, for example, FIG. 2, when glass was formed into a film-shaped glass plate having a thickness of 200 μm or less, that is, formed into the state of a so-called glass film 10, the glass film 10 was wound around a winding core 12 provided with a supporting bar 11 so that a glass roll 15 might be produced, and the glass roll 15 was kept in the state of not being in contact with a placement surface such as a floor surface by holding the supporting bar 11 with a shaft holding member 13 of a base 14 placed on the placement surface, the glass film was sometimes damaged at an inner layer portion of the glass roll 15.

The present invention has been made to solve the above-mentioned problem of the prior art, and has an object to suppress the damage of a glass film having a thickness of 0.5 to 300 μm at an inner layer portion of a glass roll formed by winding the glass film.

### Means for Solving the Problems

The inventors of the present invention have made intensive studied to achieve the above-mentioned object. Consequently, the inventors have found that the reason for partial damage of the glass film 10 is that, as the length of the glass film 10 to be wound around the winding core 12 becomes longer, the weight of the glass roll 15 becomes heavier, and then, a large load is applied to the glass film 10 at the inner upper side of the glass roll 15 (vicinity of the upper portion of the winding core 12), leading to the damage. As a result, the inventors have proposed the present invention.

A glass roll according to claim 1 of the present invention includes a glass film having a thickness of 0.5 to 300 μm and a density of less than 2.45 g/cm³, the glass film being wound into a roll shape.

According to the glass roll of claim 2 of the present invention, in the glass roll of claim 1, the glass film has a winding length of 50 m or more.

According to the glass roll of claim 3 of the present invention, in the glass roll of claim 1 or 2, both surfaces of the glass film are unpolished.

According to the glass roll of claim 4 of the present invention, in the glass roll of any one of claims 1 to 3, the glass film is manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO.

According to the glass roll of claim 5 of the present invention, in the glass roll of any one of claims 1 to 4, the glass film is wound around a winding core.

According to the packaged glass roll of claim 6 of the present invention, the glass roll of any one of claims 1, 2, 3, 4, and 5 is held so that the glass roll is out of contact with a placement surface below the glass roll.

According to the packaged glass roll of claim 7 of the present invention, in the packaged glass roll of claim 6, a supporting bar is provided as a central shaft of the glass roll, and the supporting bar is held by a shaft holding member of a base placed on the placement surface.

According to the packaged glass roll of claim 8 of the present invention, in the packaged glass roll of claim 6, a supporting bar is provided as the central shaft of the glass roll, and the glass roll is held above the placement surface by being hung and supported with the supporting bar.

According to the packaged glass roll of claim 9 of the present invention, in the packaged glass roll of claim 6, the glass film is wound around the winding core, the winding core has flanges at both end portions thereof, and the flanges are partially abutted at outer peripheral surfaces thereof on the placement surface.

### Effects of the Invention

The glass roll according to claim 1 of the present invention includes the glass film having a thickness of 0.5 to 300 μm, and hence the glass film can be easily wound into a roll shape. Further, the glass film has a density of less than 2.45 g/cm³, that is, is very light. Thus, even in the case where a long glass film 10 is wound around the winding core 12, and the glass roll 15 is placed above the base 14 having the shaft holding member 13 via the supporting bar 11, for example, in such a packing form as illustrated in FIG. 2, a load applied to the glass film 10 at the inner upper side of the glass roll 15 (vicinity of the upper portion of the winding core) is reduced. Therefore, the damage of the glass film 10 at an inner layer portion of the glass roll 15 can be suppressed effectively.

The glass roll according to claim 2 of the present invention includes the glass film having a winding length of 50 m or more. Even if a longer glass film is wound into a roll shape having many layers, the weight of the glass roll can be kept light because the density of the glass film is less than 2.45 g/cm³. Accordingly, the damage of the glass film at an inner layer portion of the glass roll can be suppressed effectively. Besides, a long glass film having a length of 50 m or more is wound into a roll shape, and hence the long glass film can be subjected to surface treatment by a roll-to-roll method. Thus, it is possible to manufacture efficiently a substrate for a flat panel display, a solar cell, an organic EL lighting, or the like. A glass film having a longer winding length is more suitable for the roll-to-roll method. Thus, while the prevention of the damage of the glass film at the inner layer portion of the glass roll is taken into consideration, the winding length of the glass film is lengthened to preferably 100 m or more, 200 m or more, 500 m or more, and more preferably 1,000 m or more.

The glass roll according to claim 3 of the present invention includes the glass film both surfaces of which are unpolished, and the glass film is excellent in surface flatness. Note that, when the surfaces of the glass film are observed with an atomic force microscope (AFM), countless minute flaw-like polish streaks can be found on polished surfaces, but, on the other hand, it is not possible to find, on unpolished surfaces, such countless minute flaw-like polish streaks as those formed on the polished surfaces.

The glass roll according to claim 4 of the present invention includes the glass film manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO, and hence the density of less than 2.45 g/cm³ is likely to be attained.

The glass roll according to claim 5 of the present invention includes the glass film wound around a winding core. When the glass film is wound around the winding core, the glass film can be fixed around the winding core, and hence the glass film can be firmly wound.

The packaged glass roll according to claim 6 of the present invention includes the glass roll according to any one of claims 1 to 5 which is held so as not to be in contact with a placement surface below the glass roll, and hence the damage of the glass roll caused by its contact with the placement surface can be prevented. Note that the placement surface here means a floor surface below the glass roll, the inner bottom surface of a packing box, or the like.

The packaged glass roll according to claim 7 of the present invention includes the supporting bar as the central shaft of the glass roll, and the supporting bar is held by the shaft holding member of the base placed on the placement surface. Accordingly, the damage of the glass roll caused by its contact with the placement surface can be reliably prevented. In addition, because the density of the glass film is less than 2.45 g/cm³, the total weight of the glass roll can be diminished, and hence a load applied to the shaft holding member can be reduced.

The packaged glass roll according to claim 8 of the present invention includes the supporting bar as the central shaft of the glass roll, and the supporting bar is held above the placement surface by being hung and supported. Accordingly, the damage of the glass roll caused by its contact with the placement surface can be reliably prevented. In addition, because the density of the glass film is less than 2.45 g/cm³, the total weight of the glass roll can be diminished, and hence the glass roll can be hung easily.

The packaged glass roll according to claim 9 of the present invention includes the glass film wound around the winding core, the winding core has flanges at both end portions thereof, and the flanges are partially abutted at the outer peripheral surfaces thereof on the placement surface. Accordingly, the damage of the glass roll caused by its contact with the placement surface can be reliably prevented. In addition, because the density of the glass film is less than 2.45 g/cm³, the total weight of the roll body can be diminished, and hence a load applied to each flange at the time of placing the glass roll above the placement surface can be reduced.

### BRIEF DESCRIPTION OF THE DRAWINGS

FIG. 1 is an explanatory diagram illustrating a method of manufacturing a glass roll according to the present invention.

FIG. 2 is a perspective view illustrating the state that a supporting bar is fitted as the central shaft of a glass roll and the supporting bar is held by a shaft holding member of a base.

FIG. 3 is a perspective view illustrating the state that flanges are provided to a winding core of the glass roll.

### MODE FOR CARRYING OUT THE INVENTION

Described hereinafter is a preferred embodiment of a glass roll according to the present invention.

Each glass film that is used in the present invention has a thickness of 0.5 to 300 μm. A glass film having such thickness can be obtained by a down-draw method, that is, by drawing glass downward and continuously forming the glass into a film-shaped glass. When the thickness of the glass film is smaller than 0.5 μm, the glass film is likely to be damaged. When the thickness of the glass film is larger than 300 μm, its flexibility becomes insufficient, and hence the glass film is difficult to wind into a roll shape. The thickness of the glass film is preferably 5 to 200 μm, 5 to 100 μm, and more preferably 5 to 50 μm.

The glass film has a density of less than 2.45 g/cm³, and hence the weight of a glass roll can be reduced. For example, even in the case where a glass film having a length of 50 m or more is wound, and a supporting bar is fitted as the central shaft of the resultant glass roll so as to hold the glass roll while the state that part of the outer surface of the glass roll is not in contact with a placement surface is maintained, a load applied to the glass film at an inner upper side of the glass roll is diminished. Thus, the damage of the glass film can be suppressed. As the length of the glass film is longer, the density of the glass film is desirably lower. For example, when the winding length of the glass film is 100 m or more, the density is desirably less than 2.42 g/cm³, and when the winding length is 200 m or more, the density is desirably less than 2.40 g/cm³.

The width of the glass film is preferably 50 mm or more. Even if a glass film having a broader width than the foregoing is wound into a roll shape, the total weight of the resultant glass roll can be diminished because the density of the glass film is less than 2.45 g/cm³. When an organic EL display is produced, there is performed the operation that a plurality of TFTs are formed on the surface of one glass substrate and the TFTs are then cut panel by panel, the operation being called multiple patterning. Accordingly, as the width of a glass film is larger, cost per panel can be reduced more. Thus, the width of the glass film is preferably 100 mm or more, 200 mm or more, 300 mm or more, 500 mm or more, 600 mm or more, 800 mm or more, and more preferably 1,000 mm or more. Note that, when, for example, an overflow down-draw method is adopted, the width of the glass film can be adjusted by changing the size and shape of a trough, the position of edge rollers, and the like, all of which are factors for forming glass into a plate-shaped glass. Note that the edge rollers refer to the rollers positioned closest to the trough and have the functions of holding both end portions in the width direction of a glass ribbon having flowed down from the trough and of applying a tensile force to the glass ribbon in the width direction (lateral direction) while cooling the glass ribbon.

A down-draw method, which facilitates the production of a thinner glass, is suitable as a method of forming a glass film. Any one of an overflow down-draw method, a slot down-draw method, and a redraw method can be adopted as the down-draw method. It is particularly preferred to adopt the overflow down-draw method or the redraw method, because a glass film having excellent surface quality is provided without polishing its surfaces. The reason why the glass film having excellent surface quality can be manufactured by the overflow down-draw method or the redraw method is that the surfaces (both surfaces) of a glass ribbon, which should eventually be the surfaces of the glass film, do not contact anything but air, and hence the surfaces of the glass film are each formed in the state of a free surface. Here, the overflow down-draw method is a method of forming a flat glass by supplying molten glass into a trough made of a refractory and having a tub portion at the upper portion, causing the molten glass to overflow from both sides of the tub portion of the trough, causing both molten glass flows to join at the lower end portion of the trough, and down-drawing the joined molten glass downward. On the other hand, the redraw method is a method involving heating a glass matrix having a plate shape and down-drawing the glass matrix downward to form (reform) a flat glass thinner than the glass matrix.

When the glass film is formed by the overflow down-draw method, glass has a liquidus temperature of preferably 1,200° C. or less, 1,150° C. or less, 1,130° C. or less, in order to prevent denitrification from occurring in the glass at the time of forming the glass film. Further, the viscosity of the glass at the liquidus temperatures is preferably 10^{5.0} dPa·s or more, 10^{5.2} dPa·s or more.

Further, because various functional films are formed on a surface of the glass film, the glass film preferably has a thermal expansion coefficient matching with the thermal expansion coefficient of each of the functional films, in addition to having flat surfaces. To be specific, the glass film has a thermal expansion coefficient of preferably 25 to 40×10⁻⁷/° C., particularly preferably 30 to 35×10⁻⁷/° C., in the temperature range of 30 to 380° C.

Further, the glass film is required to have heat resistance because the glass film is exposed to high temperatures at the time of manufacturing devices such as a flat panel display. Thus, the strain point of the glass, which is an index of the heat resistance of the glass, is preferably 600° C. or more, 630° C. or more, particularly preferably 650° C. or more.

Further, the glass film is preferably manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO, because the meltability, formability, heat resistance, and the like of the glass improve and the density of the glass easily decreases.

The reason why the content of each glass component was limited as described above is the following.

As the content of SiO₂ increases, the density of the glass decreases more easily, but it is not preferred that the content of SiO₂ be too much, because the meltability of the glass lowers. Thus, the content of SiO₂ is 58 to 70%, preferably 60 to 68%, more preferably 60 to 65%.

When Al₂O₃ is contained at a predetermined ratio, the balance in glass composition is adjusted, and hence the denitrification of the glass can be suppressed easily. Thus, the content of Al₂O₃ is 12 to 22%, preferably 13 to 20%, more preferably 15 to 18%.

B₂O₃ is a component that functions as a flux, lowers the high-temperature viscosity of the glass, and improves the meltability, but when the content of B₂O₃ is too much, the heat resistance is apt to lower. The content of B₂O₃ is 3 to 17%, preferably 3 to 15%, more preferably 5 to 14%, still more preferably 7 to 12%.

MgO, CaO, SrO, and BaO, which are alkaline-earth metal oxides (RO), are components that lower the high-temperature viscosity of the glass and improve the meltability, but when their content increases, the density becomes higher. Thus, the content of MgO+CaO+SrO+BaO (total content of MgO, CaO, SrO, and BaO) should be restricted to 5 to 12%, preferably 5 to 11%.

Note that, when the content of each of MgO, CaO, SrO, and BaO is too much, the glass is likely to denitrify at the time of forming. Thus, the content of MgO should be restricted to 0 to 8%, preferably 0 to 6%, more preferably 0 to 3%. Further, the content of CaO should be restricted to 0 to 10%, preferably 1 to 9%, more preferably 3 to 8%. Further, the content of SrO should be restricted to 0 to 10%, preferably 0 to 6%, more preferably 0 to 3%, still more preferably 0.5 to 3%. Further, the content of BaO should be restricted to 0 to 10%, preferably 0 to 6%, more preferably 0 to 3%, still more preferably 0 to 1%. Besides, because BaO is a component that easily increases the density of the glass, it is particularly preferred that the glass be substantially free of BaO.

In the present invention, in consideration of the meltability, formability, density, and the like of the glass, one kind or two or more kinds selected from TiO₂, Nb₂O₅, La₂O₃, ZnO, ZrO₂, Gd₂O₃, and Y₂O₃ can be contained at up to 10% in addition to the above-mentioned components.

Further, as a fining agent, one kind or two or more kinds selected from As₂O₃, Sb₂O₃, CeO₂, SnO₂, F, Cl, and SO₃ may be contained at 0 to 3%. However, it is necessary to refrain as much as possible from the use of As₂O₃, Sb₂O₃, and F, in particular As₂O₃ and Sb₂O₃, from an environmental viewpoint, and each content thereof is desirably restricted to less than 0.1%. On the other hand, SnO₂, Cl, and SO₃ are desirably contained in total at 0.001 to 1%, preferably 0.01 to 0.5%. SnO₂ is desirably contained at 0 to 1%, preferably 0.01 to 0.5%, particularly preferably 0.05 to 0.4%.

Li₂O, Na₂O, and K₂O are components that lower the viscosity of the glass and adjust the thermal expansion coefficient, but, when they are added in a large amount, the liquidus viscosity lowers and the glass is likely to denitrify at the time of forming. Thus, the content of Li₂O+Na₂O+K₂O (total content of Li₂O, Na₂O, and K₂O) should be 3% or less, 1% or less, and the glass is desirably substantially free of them.

In the present invention, when the glass film is wound into a roll shape, the glass film may be wound together with a protective sheet. As a result, both surfaces of the glass film are protected with the protective sheet. Besides, when the glass film is taken out from the glass roll, the glass film can be easily detached from the protective sheet, and hence the damage of the glass film at the time of unwinding it can be reduced to the extent possible.

As the protective sheet, there may be used a buffer material made of a resin such as an ionomer film, a polyethylene film, a polypropylene film, a polyvinyl chloride film, a polyvinylidene chloride film, a polyvinyl alcohol film, a polypropylene film, a polyester film, a polycarbonate film, a polystyrene film, a polyacrylonitrile film, an ethylene vinyl acetate copolymer film, an ethylene-vinyl alcohol copolymer film, an ethylene-methacrylic acid copolymer film, a polyamide resin film (nylon film), a polyimide resin film, or cellophane, inserting paper, or a nonwoven fabric, for example. In particular, a polyethylene foam resin sheet is optimal because the polyethylene foam resin sheet can absorb impact excellently, and has high strength with respect to a tensile stress.

The glass roll according to the present invention is preferably wound around a winding core. As a result, when the glass film is wound, the glass film can be fixed to the winding core, and hence the glass film can be wound firmly. Further, even if an external pressure is applied to the resultant glass roll produced by winding the glass film, the glass film is prevented from bending inside by the existence of the winding core. Thus, it is possible to prevent an improper tensile stress from being applied to the glass film, and the damage of the glass film can be prevented more reliably.

The length of the winding core is preferably longer than the width of the glass film. As a result, both ends of the winding core can protrude from both side edge portions of the glass roll, and minute flaws and chippings caused by striking and sticking, etc. can be easily prevented from occurring at the side edge portions of the glass film.

As a material of the roll core, for example, there can be used metals such as an aluminum alloy, a stainless steel, a manganese steel, and a carbon steel, thermosetting resins such as a phenolic resin, a urea resin, a melamine resin, an unsaturated polyester resin, an epoxy resin, a polyurethane resin, and a diallyl terephthalate resin, thermoplastic resins such as polyethylene, polypropylene, polystyrene, an AS resin, an ABS resin, a methacrylate resin, and vinyl chloride, reinforced plastics obtained by mixing those thermosetting resins or thermoplastic resins with reinforcement fibers such as a glass fiber and a carbon fiber, and paper cores. In particular, an aluminum alloy and a reinforced plastic are preferred because the materials are excellent in strength, and further, paper is preferred because the paper allows a reduction in weight.

When a supporting bar is provided as the central shaft of the glass roll, the winding core and the supporting bar may be provided as an integrated part, or they may be produced separately and then integrated. For example, it is possible to make a hole in the central portion of the winding core and insert the supporting bar in the hole, thereby integrating them. A similar material to that of the winding core can be used as a material of the supporting bar.

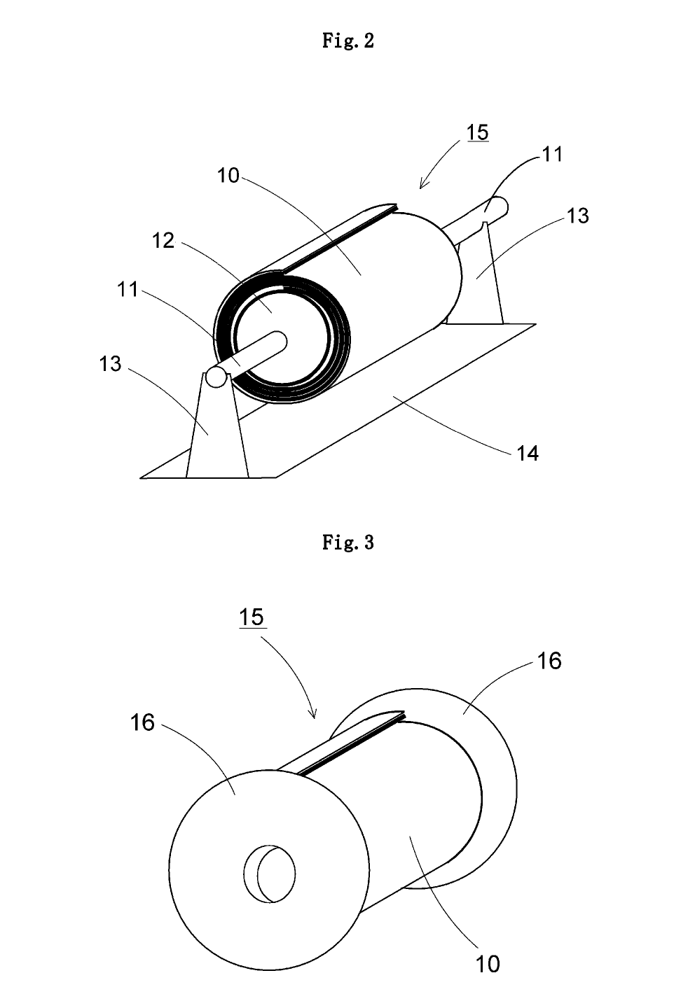

When the glass roll according to the present invention is placed in its lateral direction or longitudinal direction, the glass roll is likely to be damaged from the placement surface side owing to its own weight, and hence the glass roll is desirably formed into a packaged glass roll which includes a glass roll kept in the state of not being in contact with the placement surface (floor surface or inner bottom surface of a packing box). It is desired that, as illustrated in, for example, FIG. 2, the long glass film 10 be wound, the supporting bar 11 be fitted as the central shaft, and the supporting bar 11 be held by the shaft holding member 13 of the base 14 placed on the placement surface. There may be adopted, as a packaging form except that illustrated in FIG. 2, another form in which a supporting bar fitted as the central shaft of a glass roll is hung and supported in a packing box to prevent part of the outer surface of the glass roll from contacting a placement surface (inner bottom surface of the packing box). Besides, as illustrated in FIG. 3, there may be adopted another form in which the glass film 10 is wound around a winding core, the flanges 16 are fitted to both end portions of the winding core, and part of the outer peripheral surface of each of the flanges 16 is brought into contact with a placement surface (inner bottom surface of a packing box) to prevent the glass roll 15 from contacting the placement surface. Note that, although the shape of each of the flanges 16 illustrated in FIG. 3 is circular, if polygonal flanges are adopted, the glass roll 15 can be prevented from rolling when the polygonal flanges are placed on the placement surface. Further, the flanges 16 may be attachable to and detachable from the winding core. In addition, such packaged glass rolls as described above are each contained preferably in a packing box not shown and having good airtightness, because each glass roll can be maintained in a clean state.

### EXAMPLES

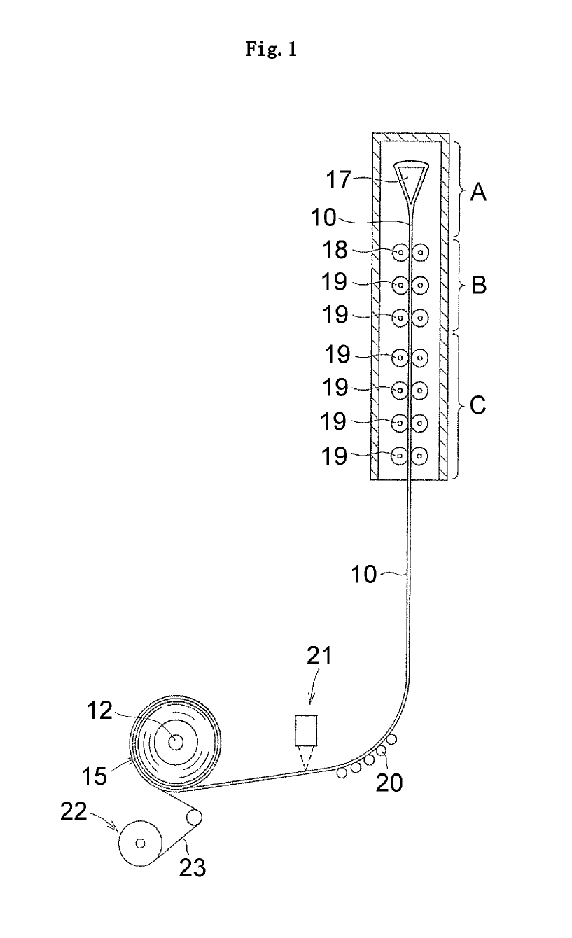

FIG. 1 is an explanatory diagram illustrating a method of manufacturing a glass roll according to the present invention. In the figure, numeral 10 denotes a glass film, numeral 12 denotes a winding core, numeral 15 denotes a glass roll, numeral 18 denotes an edge roller, numeral 19 denotes a drawing roller, numeral 20 denotes a supporting roller, numeral 21 denotes a both-end-portion separating apparatus, and numeral 23 denotes a protective sheet.

Molten glass flows are joined at the lower end of a trough 17 used in an overflow down-draw method and formed into the glass film 10 having a plate shape. The glass film 10 is drawn downward by the plurality of drawing rollers 19 while being provided with a tensile force in the width direction by the edge rollers 18. As a result, the glass film 10 passes through a forming zone A, an annealing zone (annealer) B, and a cooling zone C, the temperatures of which are strictly controlled. The glass film 10 that has passed through the cooling zone C is bent in the horizontal direction while being held from beneath itself by the supporting rollers 20. After that, both end portions in the width direction (selvage portions) of the glass film 10 are removed by the both-end-portion separating apparatus 21. Suitable as the both-end-portion separating apparatus 21 is a laser cutting apparatus for cutting and separating both end portions (selvage portions) of the glass film 10 by applying laser light in the direction parallel to a plate-drawing direction. The use of the laser cutting apparatus makes the cut surface of the glass film 10 smoother, and hence the glass film 10 does not break easily.

The protective sheet 23 drawn out from a protective sheet roll 22 is superimposed on an outer peripheral surface of the glass film 10 from which both the end portions in the width direction have been separated, and the glass film 10 and the protective sheet 23 are wound into a roll shape along the surface of the winding core 12. After the glass film 10 is wound by a predetermined length, the glass film 10 is cut in the width direction by a width-direction cutting machine (whose illustration is omitted), and the glass roll 15 is eventually manufactured. Note that the protective sheet 23 is also cut at the same time so as to be long enough to cover the outer surface of the glass roll 15.

Table 1 shows the composition and characteristics of each glass film. No. 1 to 7 mean glass films of examples, and No. 8 means a glass film of a comparative example.

TABLE 1

| Glass | | | | | | | | |
|---|---|---|---|---|---|---|---|---|
| composition (wt %) | No. 1 | No. 2 | No. 3 | No. 4 | No. 5 | No. 6 | No. 7 | No. 8 |
| SiO₂ | 63.9 | 62.9 | 59.3 | 61.5 | 64 | 62 | 62 | 60 |
| Al₂O₃ | 16 | 17 | 15.5 | 15.5 | 16 | 17 | 15 | 15 |
| B₂O₃ | 10 | 10 | 16.5 | 12 | 10 | 9 | 10 | 10 |
| MgO | — | 1 | — | 5.5 | — | 3 | 1 | — |
| CaO | 8 | 8 | 8.5 | 5 | 7 | 5 | 5 | 5 |
| SrO | 1 | 1 | — | — | 1 | — | 3 | 6 |
| BaO | 1 | — | — | — | — | 3 | 2 | 2 |
| ZnO | — | — | — | — | 1 | — | — | 1 |
| Sb₂O₃ | — | — | — | 0.3 | 1 | 1 | 2 | 0.9 |
| Sn₂O₂ | 0.1 | 0.1 | 0.2 | 0.2 | — | — | — | 0.1 |
| Density (g/cm³) | 2.39 | 2.39 | 2.33 | 2.39 | 2.38 | 2.42 | 2.40 | 2.50 |
| Thermal expansion | 32 | 32 | 33 | 32 | 31 | 32 | 33 | 38 |
| coefficient | | | | | | | | |
| (×10⁻⁷/° C.) | | | | | | | | |
| Strain point (° C.) | 660 | 665 | 630 | 670 | 660 | 650 | 650 | 650 |
| 10^{4.0} dPa · s (° C.) | 1,320 | 1,290 | 1,260 | 1,250 | 1,320 | 1,290 | 1,270 | 1,290 |
| 10^{3.0} dPa · s (° C.) | 1,500 | 1,450 | 1,430 | 1,410 | 1,500 | 1,460 | 1,430 | 1,460 |
| 10^{2.5} dPa · s (° C.) | 1,610 | 1,560 | 1,530 | 1,500 | 1,600 | 1,570 | 1,530 | 1,560 |
| Liquidus | 1,100 | 1,123 | 1,060 | 1,150 | 1,100 | — | — | 1,070 |
| temperature (° C.) | | | | | | | | |
| Liquidus viscosity | 6.0 | 5.2 | 6.0 | 5.0 | 6.0 | — | — | 6.0 |
| (dPa · s) | | | | | | | | |

Each of the glass films of Sample No. 1 to 8 in Table 1 was manufactured as described below. First, a glass material was prepared so as to have a composition listed in the table, was supplied into a glass melting furnace, and was melted at 1,500 to 1,600° C. Next, the resultant molten glass was formed into a plate-shaped glass by an overflow down-draw method, and the plate-shaped glass was drawn downward to manufacture the glass film 10. The supply amount of glass and a plate-drawing speed were adjusted so that a glass film having a final width of 1,500 mm and a final thickness of 50 μm might be formed.

Next, after both the end portions of the glass film 10 were cut and separated by the both-end-portion separating apparatus 21, the resultant glass film 10 was wound around the winding core 12 to form a glass roll having a length of 50 m, and the glass roll was then cut in the width direction.

Each glass roll 15 thus obtained was used to manufacture such a packaged glass roll as illustrated in FIG. 2. After the packaged glass roll was stored for several days, the glass film 10 was taken out and checked for whether damage was present or absent. As a result, each glass film 10 (Sample No. 1 to 7) having a density of less than 2.45 g/cm³ had no damaged site, but the glass film 10 (Sample No. 8) having a density of 2.50 g/cm³ was damaged at a site positioned at the inner upper portion of the glass roll 15 (vicinity of the upper portion of the winding core).

Note that, in the table, the density was measured by a known Archimedes method.

The thermal expansion coefficient is a value measured with a dilatometer and shows an average thermal expansion coefficient in the temperature range of 30 to 380° C. Used as a sample for measuring the thermal expansion coefficient was a glass sample having a cylindrical shape with a size of 5 mmφ by 20 mm produced by placing a glass plate in a platinum boat, remelting the glass plate at 1,400 to 1,450° C. for 30 minutes, and applying R processing to the end surfaces of the resultant glass.

The strain point was measured based on a method of ASTM C336-71. As the value is higher, the heat resistance of the glass becomes higher.

Temperatures at viscosities of 10^{4.0} dPa·s, 10^{3.0} dPa·s, and 10^{2.5} dPa·s were measured by a platinum sphere pull up method. As these temperatures are lower, the meltability of the glass becomes more excellent.

As for the liquidus temperature, glass was pulverized, passed through a standard sieve of 30 mesh (500 μm), and a glass powder remaining on 50 mesh (300 μm) was placed in a platinum boat, kept in a temperature gradient furnace for 24 hours, and then the temperature at which the crystal thereof was deposited was measured. The liquidus viscosity refers to the viscosity of glass at a liquidus temperature. As glass has a lower liquidus temperature and a higher liquidus viscosity, the glass is better in denitrification resistance and better in formability.

### INDUSTRIAL APPLICABILITY

The glass roll of the present invention can be suitably used as a glass roll that is formed for winding a glass film used for a flat panel display, a solar cell, an organic EL lighting, or the like.

### REFERENCE SIGNS LIST

10 glass film
11 supporting bar
12 winding core
13 shaft holding member
14 base
15 glass roll
16 flange
17 trough
18 edge roller
19 drawing roller
20 supporting roller
21 both-end-portion separating apparatus
22 protective sheet roll
23 protective sheet

1. A glass roll, comprising a glass film having a thickness of 0.5 to 300 μm and a density of less than 2.45 g/cm³, the glass film being wound into a roll shape.

2. The glass roll according to claim 1, wherein the glass film has a winding length of 50 m or more.

3. The glass roll according to claim 1, wherein both surfaces of the glass film are unpolished.

4. The glass roll according to claim 1, wherein the glass film is manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO.

5. The glass roll according to claim 1, wherein the glass film is wound around a winding core.

6. A packaged glass roll, wherein the glass roll according to claim 1 is held so that the glass roll is out of contact with a placement surface below the glass roll.

7. The packaged glass roll according to claim 6, comprising a supporting bar as a central shaft of the glass roll, wherein the supporting bar is held by a shaft holding member of a base placed on the placement surface.

8. The packaged glass roll according to claim 6, comprising a supporting bar as a central shaft of the glass roll, wherein the supporting bar is held above the placement surface by being hung and supported.

9. The packaged glass roll according to claim 6, wherein the glass film is wound around the winding core, the winding core has flanges at both end portions thereof, and the flanges are partially abutted at outer peripheral surfaces thereof on the placement surface.

10. The glass roll according to claim 2, wherein both surfaces of the glass film are unpolished.

11. The glass roll according to claim 2, wherein the glass film is manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO.

12. The glass roll according to claim 3, wherein the glass film is manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO.

13. The glass roll according to claim 10, wherein the glass film is manufactured from glass containing a composition, in terms of mass %, of 58 to 70% of SiO₂, 12 to 22% of Al₂O₃, 3 to 17% of B₂O₃, and 5 to 12% of MgO+CaO+SrO+BaO.

14. The glass roll according to claim 2, wherein the glass film is wound around a winding core.

15. The glass roll according to claim 3, wherein the glass film is wound around a winding core.

16. The glass roll according to claim 4, wherein the glass film is wound around a winding core.

17. The glass roll according to claim 10, wherein the glass film is wound around a winding core.

18. The glass roll according to claim 11, wherein the glass film is wound around a winding core.

19. The glass roll according to claim 12, wherein the glass film is wound around a winding core.

20. The glass roll according to claim 13, wherein the glass film is wound around a winding core.
